(19) United States
(12) Patent Application Publication
(10) Pub. No.: US 2007/0083280 A1
(43) Pub. Date: Apr. 12, 2007

(54) Method and system for three dimensional work instructions for modification processes

(76) Inventors: Timothy Stumpf, St. Charles, MO (US); Raymond Heininger, St. Peters, MO (US)

Correspondence Address: KLEIN, O'NEILL & SINGH, LLP, 43 CORPORATE PARK, SUITE 204, IRVINE, CA, 92606, US

(21) Appl. No.: 11/244,934

(22) Filed: Oct. 6, 2005

(51) Int. Cl. G06F 19/00

(52) U.S. Cl. 700/95; 700/107

(57) ABSTRACT

A method and system for providing three dimensional (3D) work instructions for modification tasks is provided. The method includes, determining if a 3D model exists for at least a part of an assembly; extracting model based data from a product data manager; assembling a component list for a work instruction with 3D source data; determining if recent model based process data is available for use; and creating a work instruction with 3D source data. The system includes a computing system for executing the foregoing steps.

### BACKGROUND OF THE INVENTION

1. Field of the Invention

The present invention relates to providing work instructions using a computing system, and more particularly, to a system and method for providing three dimensional work instructions.

2. Background

Precise and helpful work instructions in a manufacturing environment contribute to the overall quality of products as well as the efficiency of the production process. Computer aided drawings and design tools are used to design products. The drawings can be two-dimensional (2-D) or three dimensional (3D).

Often, a typical work instruction includes text and 2-D drawings. The drawings are often very complex, especially if a complex assembly/product (for example, an aircraft) is involved. When a complex assembly is being repaired or serviced by a support organization (for example, maintenance department of a Company), the mechanics and the personnel in the field have to use/interpret complex two-dimensional drawings and instructions to service or repair products. Sometimes the number of drawings can be numerous pages. These personnel have to spend considerable amount of time (depending on the complexity of the product/assembly) in trying to interpret the complex work instructions and hence, this is commercially undesirable.

Therefore, there is a need for a method and system to provide better work instructions, especially to support organizations.

### SUMMARY OF THE INVENTION

In one aspect of the present invention, a method and system for providing three dimensional (3D) work instructions for modification tasks is provided. The method includes, determining if a 3D model exists for at least a part of an assembly; extracting model based data from a product data manager; assembling a component list for a work instruction with 3D source data; determining if recent model based process data is available for use; and creating a work instruction with 3D source data. The system includes a computing system for executing the foregoing steps.

This brief summary has been provided so that the nature of the invention may be understood quickly. A more complete understanding of the invention can be obtained by reference to the following detailed description of the preferred embodiments thereof in connection with the attached drawings.

### BRIEF DESCRIPTION OF THE DRAWINGS

The foregoing features and other features of the present invention will now be described with reference to the drawings of a preferred embodiment. In the drawings, the same components have the same reference numerals. The illustrated embodiment is intended to illustrate, but not to limit the invention. The drawings include the following Figures:

FIG. 1 is a block diagram of an overall system used according to an embodiment of the present invention;

FIG. 2 is a block diagram showing the internal functional architecture of a computing system;

FIG. 3 is process flow diagram for providing 3Dimensional work instructions, according to one aspect of the present invention;

FIGS. 4A and 4B show examples of providing work instruction, according to one aspect of the present invention.

### DETAILED DESCRIPTION OF THE PREFERRED EMBODIMENTS

The following detailed description is of the best currently contemplated modes of carrying out the invention. The detailed description is not to be taken in a limiting sense, but the detailed description is made merely for the purpose of illustrating the general principles of the invention, since the scope of the invention is best defined by the appended claims.

To facilitate an understanding of the preferred embodiment, the general architecture and operation of a top-level system architecture and a computing system will be described. The specific architecture and operation of the preferred embodiments will then be described with reference to the general architecture.

Computer System Architecture

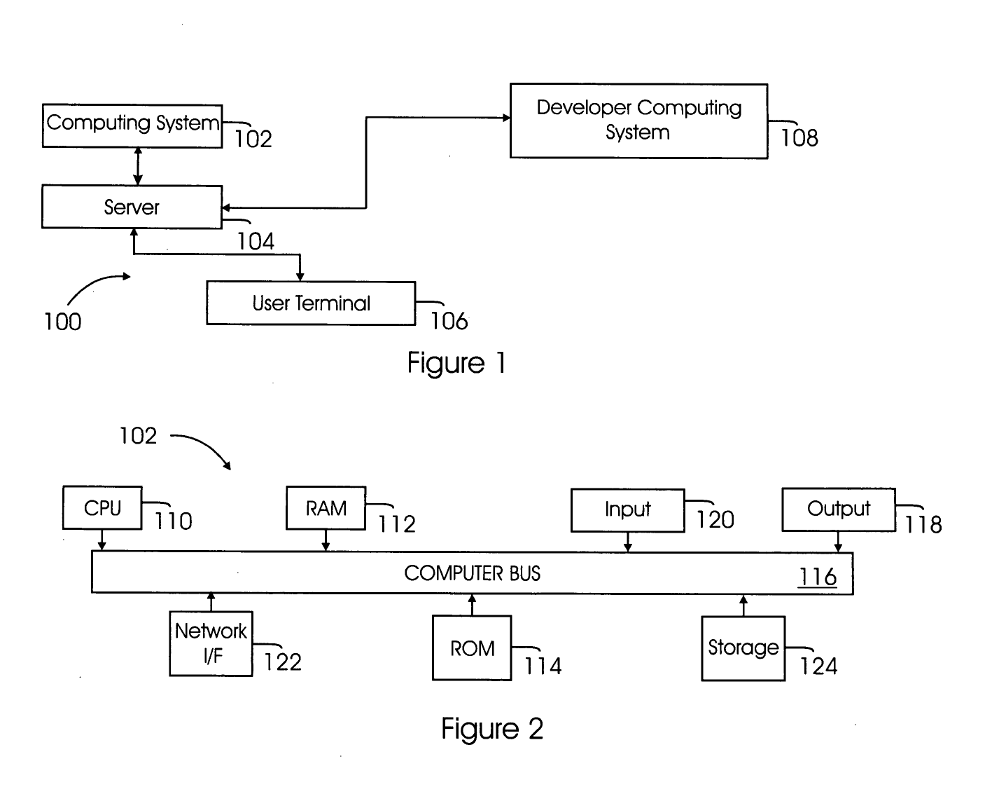

FIG. 1 shows a top-level architecture/system 100 for developing and distributing 3D work instructions, according to one aspect of the present invention. System 100 includes various computing systems, for example, server 104, developer computing system 102, and developer computing system 108 and user terminal 106.

System 102 and 108 can be used by designers using CAD tools to generate 3D geometry and source data for products, components and/or assemblies. 3D data can be stored in central server 104 that is accessible by user terminal 106. Terminal 106 can be a personal digital assistant, a mobile computing device (for example, a laptop, a notebook or any other mobile computing device) or even a desktop computer. Terminal 106 allows a user (service technician or any personnel) to access 3D based work instructions that are easy to follow compared to 2D instructions.

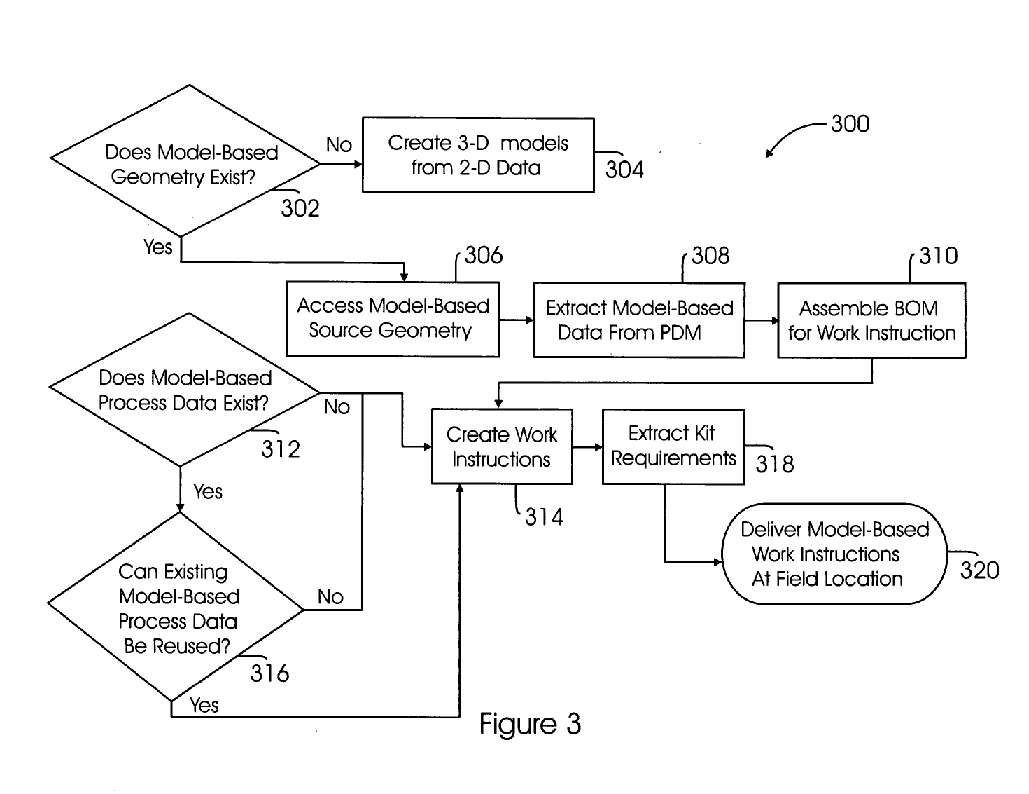

FIG. 2 shows an abstracted representation of a computer system (for example, computing system 102, 108, 104 and 106). Component 120 is intended to represent plural input devices, such as a mouse and keyboard that allow a user to interact with the computer system 100. Similarly, component 118 represents one or more output devices, for example, a monitor and printer (not shown).

Computer system 102 includes a central processing unit (“CPU”) (or microprocessor) 110 connected to a system bus 116. Main memory 112 (for example, Random access main memory (“RAM”)) is also coupled to system bus 116 and provides CPU 110 with access to memory storage. When executing program instructions, CPU 110 stores those process steps in RAM 112 and executes the stored process steps out of RAM 112.

Read only memory (“ROM”) 114 is provided to store invariant instruction sequences such as start-up instruction sequences or basic Input/output operating system (BIOS) sequences.

Mass storage device 124 allows computer system 102 to permanently retain large amounts of data for example, 3D source data, 3D work instructions and other data. Mass Storage device 124 may comprise storage media such as a floppy disk, a hard disk, a compact disc (CD), a digital versatile disk (DVD), and the like.

A network interface 122 is provided so that computing system 102 can have a network connection (including an Internet connection) to interface with other computers, an example of which is shown in FIG. 1.

It is noteworthy that the present invention is not limited to any particular type of computing system or network communication protocol. For example, server 104 may be a stand alone server, while user terminal 106 can be a handheld PDA that accesses server 104 using a wireless connection. System 102 and 108 may be linked to server 104 via a LAN or WAN connection.

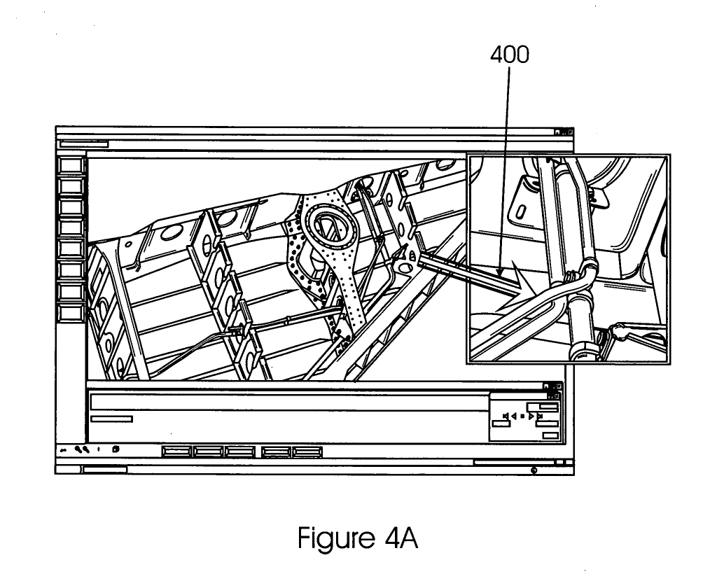

FIG. 3 shows a process flow diagram 300 for providing 3D based work instructions, especially for modification processes, according to one aspect of the present invention. The modification processes in this context means processes for maintaining/modifying/upgrading products/assemblies (for example, aircrafts) that have been produced via a regular manufacturing process. This example is based on providing instructions to a support organization (for example, maintenance and repair organization), however, the adaptive aspects are applicable to any organization that needs work instructions to assemble/repair/test products and assemblies.

The process starts in step 302, where it is determined whether 3D model based geometry exists for a component/product/assembly (jointly referred to as a “part” herein). This step may be performed based on a database query to server 104. If model based 3D geometry does not exist, then in step 304, the geometry is created and the process moves to step 306. Various CAD tools may be used to generate the geometry, for example, Unigraphics®, Pro-E® and CATIA®.

In step 306, the model based source geometry data is accessed. This data can be stored in a storage system that is accessible to server 104 and is accessible by server 104. In step 308, the model based data is extracted. In one aspect, a product data management (PDM) tool, for example, Enovia® software package is used to extract the data. In step 310, a bill of material (“BOM”) is assembled for the work instructions. The BOM lists every component that is used in an assembly.

In step 314, the work instructions are created. The work instructions may use model based process data. The process determines in step 312, if model-based process data already exists (for example, at server 104). If yes, then in step 316, the process determines if the existing model based process data can be re-used. If the data can be re-used, then it is used for building the work instructions in step 314. If model based process data does not exist, then the process moves to step 314. After the work instructions with 3D model based data, BOM and (if available) process based model data is created, the process in step 318 extracts production kit requirements. The kit requirements list the parts and materials that are needed to accomplish a task using a work instruction sequence.

Thereafter, the model based work instructions are made available at a field location, for example, at a remote site. The work instructions are available at user terminal 106. The user simply looks at the 3D instructions to perform the desired task. Furthermore, the work instructions are interactive and the user can change a view, rotate a model, zoom in and out to clarify a work instruction.

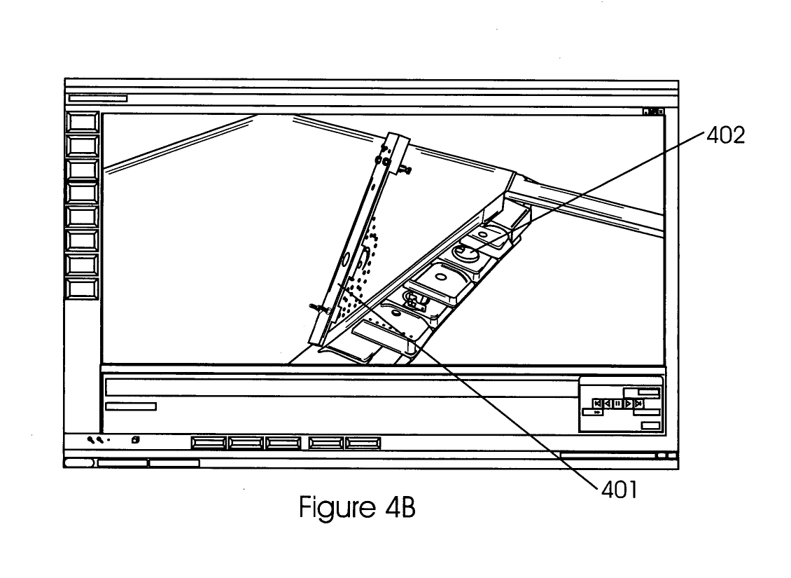

FIGS. 4A and 4B show two examples of how the 3D instructions are provided. In FIG. 4A, arrow 400 shows where the component needs to be placed. The instruction is easy to follow and hence very efficient. In FIG. 4B, show component 401 that is two be placed on component 402. Once again, the instruction is simple and allows a technician to easily perform the task.

In one aspect of the present invention, work instructions are based on 3D model data and easy to follow. This makes the assembly/repair process simple and efficient.

Although the present invention has been described with reference to specific embodiments, these embodiments are illustrative only and not limiting. Many other applications and embodiments of the present invention will be apparent in light of this disclosure and the following claims.

1. A method for providing three dimensional (3D) work instructions for modification tasks, comprising:
determining if a 3D model exists for at least a part of an assembly;
extracting model based data from a product data manager;
assembling a component list for a work instruction with 3D source data;
determining if recent model based process data is available for use; and
creating a work instruction with 3D source data.

2. The method of claim 1, wherein 3D work instructions are delivered to a user via a user terminal.

3. The method of claim 1, wherein the component list is a bill of material.

4. A system for providing three dimensional (3D) work instructions for modification tasks, comprising:
a computing system for determining if a 3D model exists for at least a part of an assembly; extracting model based data from a product data manager; assembling a component list for a work instruction with 3D source data; determining if recent model based process data is available for use; and creating a work instruction with 3D source data.

5. The system of claim 1, wherein 3D work instructions are delivered to a user via a user terminal.

6. The system of claim 1, wherein the component list is a bill of material.

7. The system of claim 4, wherein 3D source data and 3D based work instructions are stored in a storage device and accessible to a user terminal.

8. The system of claim 4, wherein the computing system is a server that is accessible by a user terminal and a developer computing system.

9. The system of claim 8, wherein the user terminal is coupled to the server via a network connection.

10. The system of claim 8, wherein the developer computing system is coupled to the server via a network connection.
